(19) United States
(12) Patent Application Publication
(10) Pub. No.: US 2006/0055353 A1
(43) Pub. Date: Mar. 16, 2006

(54) Data carrier, apparatus for processing said data and method for detecting angle information for commutation of the motor

(75) Inventors: Marco Van As, Eindhoven (NL); Michael Van Der AA, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/527,119

(22) PCT Filed: Aug. 27, 2003
(86) PCT No.: PCT/IB03/03837

§ 371 Date: Mar. 8, 2005

(30) Foreign Application Priority Data
Sep. 11, 2002 (EP) 0229222.5

(51) Int. Cl. H02K 13/00

(52) U.S. Cl. 318/439

(57) ABSTRACT

An apparatus processes the data contained in this carrier (1) by moving (rotating) it. The motor, which rotates the data carrier needs angular information on the rotary part of the motor for commutation. For measuring accurately this angle, marks are placed on the data carrier. A detector senses these marks so that the measurement of the angle is easily performed. Application: The invention is well suited for small sized optical discs.

The present invention relates to a rotating data carrier, which can be processed in an apparatus having a motor for rotating it and an angle measuring device for providing the angular position of the rotary part of the disc motor, which angular position is needed for the commutation of the motor.

This data carrier may be a rotating data carrier type for data readout, such as a CD, DVD, Blu-ray Disc and also hard disc systems. Notably, this invention applies to small sized disc systems. In these small sized disc systems, the problem is to find room for all components, which have to provide the angle measurement for commutation of the disc motor. Most conventional disc motors use electronic commutation using Hall elements or encoders placed in the motor, or this electronic commutation can for example also be achieved sensing the back-EMF from the motor. When miniaturizing the motor, both ways of electronic commutation are difficult, or impossible, to use. For the Hall elements and encoder systems the main problem is the size of the elements themselves. There is no room inside the motor for placing the Hall elements or the encoder.

The invention proposes a data carrier, which is designed for providing the angular information without wasting room in the vicinity of the motor.

Therefore, such a data carrier is characterized in that marks are placed on it for determining the angle by said angle measurer.

An advantage of the invention is that the proposed measures are well suited for the small discs called SFFO (Small Form-Factor Optical) drives. Miniaturization compels the use of proposed invention. The invention relates to a method for measuring the angle of a data carrier to provide information for commutation of the disc motor involving the following steps:
Putting marks on the data carrier,
Detecting the passing of the marks in the vicinity of a detector,
Processing the output of the detector for providing said measure,
Commuting of the disc motor/control the motor.

The invention relates to an apparatus for processing data contained in said data carrier, characterized in that it comprises an angle measurer using said marks.

These and other aspects of the invention are apparent from and will be elucidated, by way of non-limitative example, with reference to the embodiment(s) described hereinafter.

In the drawings:

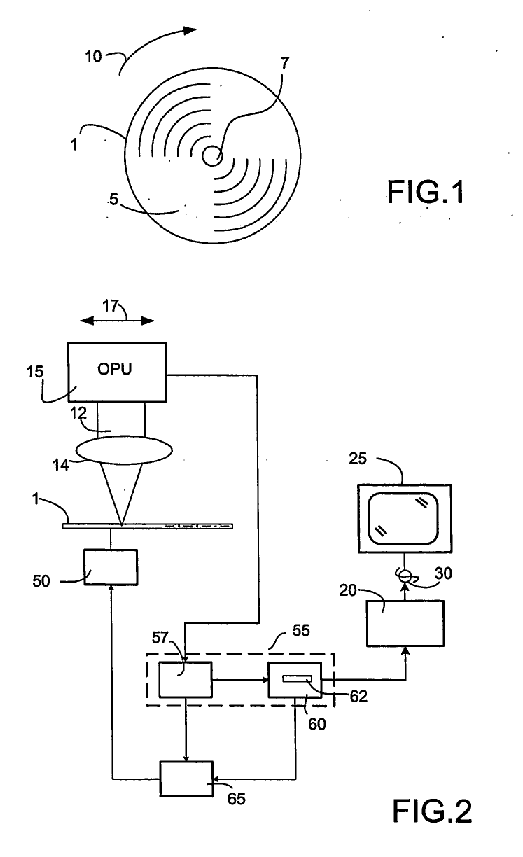

FIG. 1 shows a data carrier in accordance with the invention,

FIG. 2 shows an apparatus for processing data to/from such a data carrier,

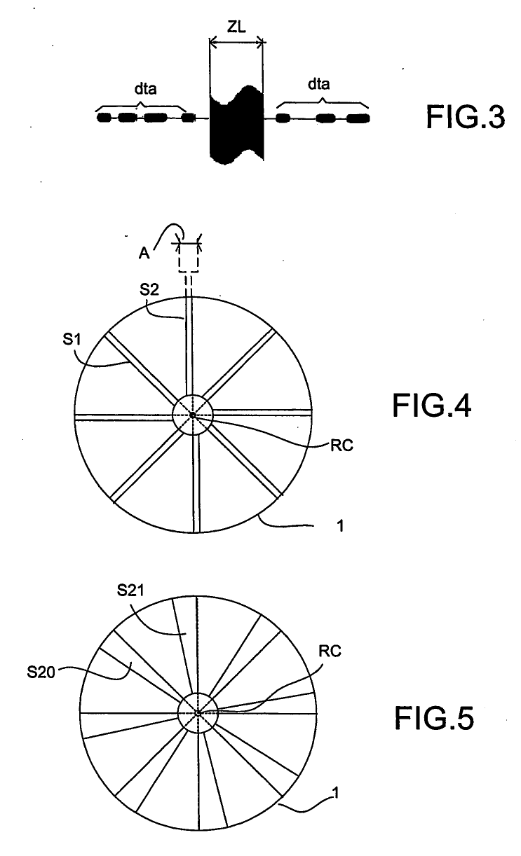

FIG. 3 is a time diagram showing the data-zone distribution on a track,

FIG. 4 shows a first embodiment of the invention,

FIG. 5 shows a second embodiment of the invention,

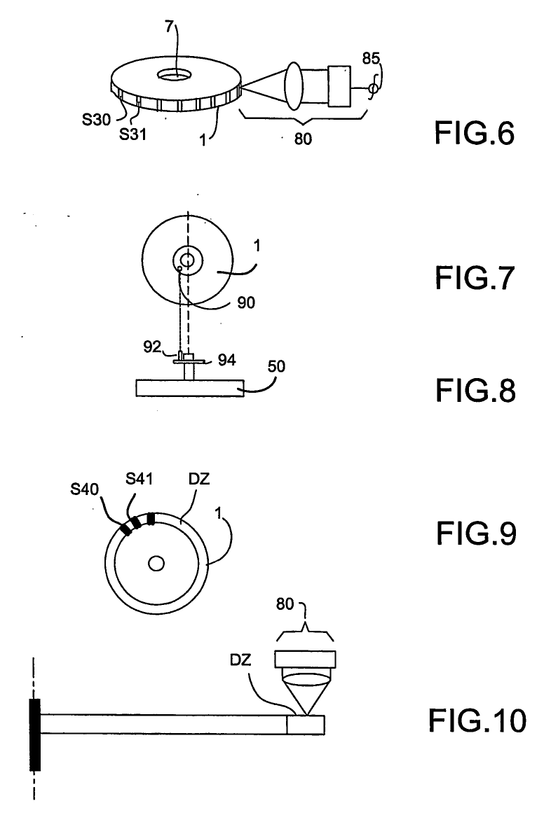

FIG. 6 shows a third embodiment of the invention,

FIG. 7 shows a fourth embodiment of the invention,

FIG. 8 shows an apparatus suited for cooperating with the embodiment shown in FIG. 7,

FIG. 9 shows a fifth embodiment of the invention,

FIG. 10 shows an apparatus suited for cooperating with the embodiment shown in FIG. 9,

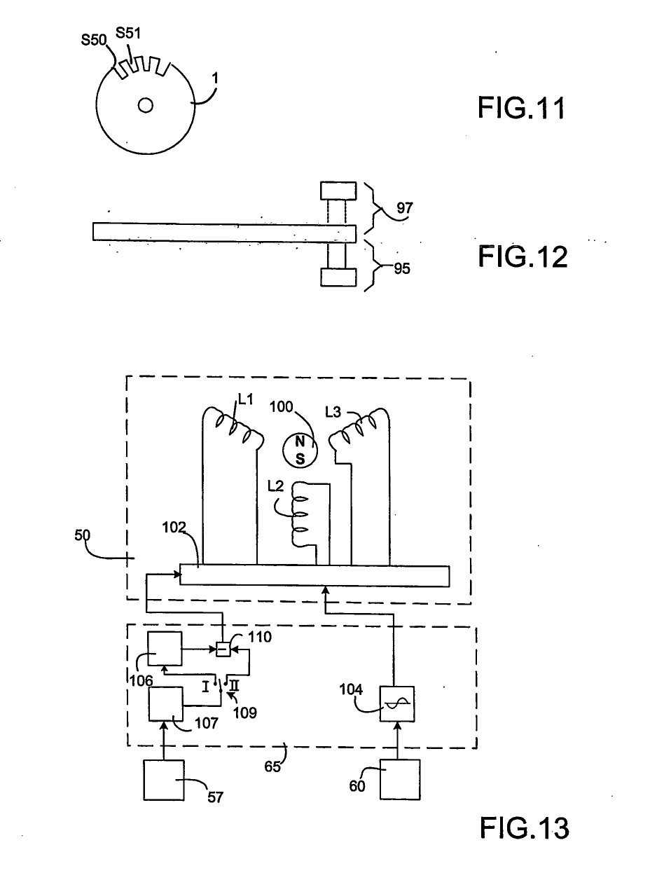

FIG. 11 shows a sixth embodiment of the invention

FIG. 12 shows an apparatus suited for cooperating with the embodiments shown in FIGS. 9 and 11,

FIG. 13 shows in more detail the driver device used in said apparatus.

In FIG. 1 is represented a data carrier 1 in accordance with the invention. This carrier is a rotating optical disc. The carrier rotates about an axis, which passes through a hole 7, in a direction indicated by an arrow 10. For obtaining an indication concerning the rotational speed, marks, which may be constituted by specific zones, are put on the disc, in accordance with an aspect of the invention.

FIG. 2 shows an apparatus in which a data carrier 1 realized in accordance with the invention is placed. The data carrier is shown in cross section. On this carrier, a lens 14 focuses a laser light beam 12. The laser is mounted in an Optical Pickup Unit (OPU) 15, which can be moved in dependence on the control of electronic circuits, not shown in the Fig, in directions indicated by the arrow 17. A servo, not shown, controls the laser beam in such a way that the focused beam is always on or in the relevant tracks. An electronic circuit 20 performs all the required processes using the data coming from the head 15. A display unit 25 can be connected to a terminal 30 so that the content of the carrier can be displayed. A motor 50 drives the carrier. For reading and recording data, it is important that the rotating speed is properly determined and the commutation of the motor rightly performed. For this purpose, the angle of the rotor of the motor (with the disc on it) has to be known.

In accordance with the invention, a distributing circuit 55 is added for detecting the passing of the marks from the signals coming from the unit 15 and for distributing the data to the electronic circuit 20 and the data related to the passing of the marks. This circuit 55 comprises a zone decoder 57 for splitting the data coming from unit 15 in two paths. The first one is related to the said zone, the second one, to the user data, which are applied to a data decoder 60 for the electronic circuit 20. The first path concerns a motor driver circuit 65 for commutation of the motor 50 and for its speed control. The speed of the motor is determined by considering the amount of data contained in a buffer memory 62.

FIG. 3 shows the data “dta” and the zone “ZL” for a disc track. The relative size of the zones compared to the data size, must be chosen such that the zones can be detected with the zone detector 57, without confusing them with data. The detection of the zones is performed easily by analyzing the signal at the output of the unit 15 as said above. It is also possible to provide a separate sensor for detecting the marks, which will be disclosed and which falls within the scope of the invention. The zones have a specific length with respect to the data written on the disc (reflectivity is, or can be, the same as the reflectivity of the data). By comparing the length ZL with dta, the positions of the zones are then determined.

FIG. 4 shows a first embodiment of the invention. In this embodiment the marks are formed by zones consisting of strips S1, S2 . . . placed in the directions of the radius of the disc. These strips have a rectangular form with a width A. The material which can be used for creating these zones may be a deposit of a reflective material. These strips have a specific length that is easy to detect. This embodiment is well suited for the control of constant angular velocity (CAV) of the disc. It is important that the start of each zone is a line through the rotational center of the disc RC.

FIG. 5 shows a second embodiment of the invention. In this embodiment the zones S20, S21 . . . are sector-shaped, which is favorable for the control of constant linear velocity (CLV), because from the length of the zone, the current radial position of the sensor (OPU, hard disc head ) can be calculated. Due to this shape, the width of the strips is larger on the outside than on the inside. Also in this case, the start of the zone is a line through the rotational center of the data carrier

FIG. 6 shows an embodiment in which the marks S30, S31, . . . are disposed along the edge of the disc 1. For taking advantage of this disposal, an edge strip detector 80 has to be provided. The unit 15 is inoperative in this case. This detector 80, which is based on reflection, provides angle information to a terminal 85, which has to be connected to the motor driver 65. The advantage of a separate detector is that it can be very cheap, and does not at all interfere with the data path.

FIG. 7 proposes to use a hole 90 disposed inside the disc in a dead zone. This hole cooperates with an apparatus shown in FIG. 8 having a pin 92 placed on a plate 94 of the disc 1. This plate is attached to the motor 50. Thanks to this disposal, the angular position of the marks on the disc is known with respect to the rotary part of the motor. This makes the motor control easier.

FIG. 9 shows an embodiment, which uses a dead zone DZ placed on the periphery of the disc 1. In this Figure, black marks S40, S41, . . . are placed at regular intervals on the periphery of the disc, a few of them being displayed in this Fig. These black marks provide, in fact, a high contrast to the disc. The device shown in FIG. 10 can detect these marks easily. In this Fig., the disc 1 is shown in cross section. A light is focused on the dead zone. The reflectivity is modified in accordance with black marks and no marks. The sensor of these marks works as said detector 80.

FIG. 11 shows an embodiment similar to the one above. But in this embodiment, marks are formed by notches S50, S51 . . . disposed at regular intervals along the periphery of the disc, a few of them being displayed in this Fig. These notches can be detected by the device shown in FIG. 12. This device comprises a light emitter 95 and a light receiver 97. The passing notch is then easily detected. It must be noted that the device shown in FIG. 10 can also be used for this embodiment. The reflectivity changes with the passing of the notches.

FIG. 13 shows in more detail a motor driver 65 used in the apparatus shown in FIG. 1 This Fig shows the windings L1, L2 and L3 of the motor 50. These windings generate a field for rotating the rotor 100. A supply generator 102 included in the motor driver 65, via a commuting unit 104, supplies these windings. The windings can generate a north or a south pole in the magnetic part of the rotor 100, depending on the direction of the current. To get the motor rotating, the windings should be driven in the following way:
a sinusoidal current is applied to all the windings L1, L2 and L3, having a 120 degree phase shift (360/number of windings) with respect to each other. This generates a rotating magnetic field inside the 3 windings. The rotor 100 follows this magnetic field. Without sensing the position of the rotor this works as long as there is no high load on the rotor (spinning up/spinning down). In these cases, the motor driver needs to know the position of the rotor to make sure it keeps rotating. This sensing of the position of the magnets with respect to the windings is done by the measures of the invention: putting marks on the disc which are to be sensed by the data pickup unit (or another sensor). The difference with Hall elements or back EMF sensing is that some discs are removable, and hence the position of the marks on the disc with respect to the rotor is not constant.

According to an aspect of the invention, during an initiation phase it is proposed to store in a memory 106 the positions of the marks measured by a mark detector measurer 107. This is done by applying the sinusoidal currents with a 360/(number of windings) phase shift to the windings. The motor then rotates, and the marks can be detected, and the position can be stored in said memory 106. A switch 109 set in position I provides a path from the measurer 107 to this memory 106. During the working phase, the stored data are compared by a comparator 110, the switch 110 being set in position II. The result of the comparison acts on the commuting unit 102 for keeping constant the relation stored in the memory 106 by shifting the commutation.

The speed of the motor can be changed. Normally, the data decoder provides the speed of the motor. This speed is determined from the content of the cited internal buffer 62. When it empties, the motor has to be speeded up ; if the buffer overflows, the motor has to slow down. In most cases the data decoder sends a signal to the motor driver to speed up or speed down. This speeding up/down the motor is done by increasing the frequency and current from the sinusoidal waves applied to the windings. As the invention proposes to monitor carefully the position of the motor, it is sure the rotor can keep up with the increasing/decreasing speed of the rotating magnetic field.

Although the disclosure was made in mentioning circular optical discs, the invention applies to optical discs having any form for instance rectangular and even to any information carrier on to which marks can be written.

The invention may be applied to other systems using optical discs. These systems may use magnetic, magneto-optical, holographic, fluorescent techniques. For realizing the marks, zones having specific magnetic, magneto-optical, holographic, fluorescent etc properties are disposed on the carrier. In all systems the read/write unit can be used to detect the zones, but also a separate sensor can be used for instance as disclosed hereinabove.

1- A rotating data carrier, which can be processed in an apparatus having a motor for rotating it and an angle measuring device for providing the angular position of the rotary part of the disc motor, which angular position is needed for the commutation of the motor, characterized in that marks are placed on it for determining the angle by said angle measurer.

2- A data carrier as claimed in claim 1 characterized in that the marks are formed by, at least, a zone placed on the carrier.

3- A data carrier as claimed in claim 1 or 2, characterized in that the data carrier is an optical disc.

4- A data carrier as claimed in claim 2 or 3 characterized in that the zones have a rectangular form.

5- A data carrier as claimed in claim 2 or 3 characterized in that the zones have a sector form.

6- A data carrier as claimed in any one of claims 3-5, characterized in that zones have a specific length with respect to the data written on the disc and have a reflectivity which may be the same as the reflectivity of the data.

7- A data carrier as claimed in claims 2 or 3 characterized in that said marks are placed on the periphery of the carrier.

8- A data carrier as claimed in claims 2 or 3 characterized in that said marks are placed on the edge of the carrier.

9- A data carrier as claimed in any one of claims 1-8, characterized in that a hole is provided in a dead zone of the disc for cooperating with a pin placed on a rotating plate attached to said motor, so that the angular position of the marks on the disc is known with respect to the rotary part (rotor) of the motor.

10- A data carrier as claimed in claim 9 characterized in that said marks are formed by notches.

11- An apparatus for processing data contained in a data carrier as claimed in any one of claims 1-10, characterized in that it comprises an angle measurer using said marks.

12- A method for measuring the angle of a data carrier involving the following steps:
putting marks on the data carrier,
detecting the passing of the marks in the vicinity of a detector,
processing the output of the detector for providing said measure,
commutation of the motor/control the motor.
